(19) United States
(12) Patent Application Publication
(10) Pub. No.: US 2025/0018786 A1
(43) Pub. Date: Jan. 16, 2025

(54) COOLANT SYSTEM FOR AN ELECTRIC VEHICLE, AND THERMAL MANAGEMENT SYSTEM

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 18/823,579

(22) Filed: Sep. 3, 2024

Related U.S. Application Data
(63) Continuation of application No. PCT/EP2023/053290, filed on Feb. 10, 2023.

(30) Foreign Application Priority Data
Mar. 2, 2022 (DE) 10 2022 104 891.8

(51) Int. Cl. B60K 11/02; B60H 1/00; B60L 50/60; H01M 10/613; H01M 10/625; H01M 10/6568; H01M 10/663

(52) U.S. Cl. CPC B60K 11/02; B60H 1/00278; B60H 1/00392; B60H 1/00914; H01M 10/613; H01M 10/625; H01M 10/6568; H01M 10/663; B60H 2001/00307; B60H 2001/00928; B60L 50/60; H01M 2220/20

(57) ABSTRACT

A coolant system for an electric vehicle for circulating a liquid coolant, comprising a plurality of components through which the coolant can flow. The components can be connected to one another, at least in at least one subset, in a coolant-conducting manner via valves and via coolant lines. Only a single multi-way valve and a single non-return valve are arranged in such a way that one of the components and another of the components can be fluidically connected to one another only via a further component, designed as a coolant pump, and via a predetermined switching state of the multi-way valve to permit a flow through the multi-way valve and the non-return valve independently of the rest of the components. A thermal management system is also provided.

This nonprovisional application is a continuation of International Application No. PCT/EP2023/053290, which was filed on Feb. 10, 2023, and which claims priority to German Patent Application No. 10 2022 104 891.8, which was filed in Germany on Mar. 2, 2022, and which are both herein incorporated by reference.

### BACKGROUND OF THE INVENTION

### Field of the Invention

The present invention relates to a coolant system for an electric vehicle, and a thermal management system for an electric vehicle, which includes a coolant system and a refrigerant circuit.

### Description of the Background Art

Coolant systems for electric vehicles and thermal management systems for electric vehicles are already known in numerous design variants from the prior art. The known coolant systems for electric vehicles for circulating a liquid coolant comprise a plurality of components through which the coolant may flow, the components being connectable to each other, at least in at least one subset, in a coolant-conducting manner with the aid of valves and with the aid of coolant lines. Complex coolant systems and thermal management systems such as those required in modern electric vehicles, however, make a very large number of valves and coolant lines necessary in the prior art. Systems of this type take up a great deal of installation space and are expensive.

This is where the present invention comes in.

### SUMMARY OF THE INVENTION

It is therefore an object of the present invention to improve a coolant system for an electric vehicle and a thermal management system for an electric vehicle, which includes a coolant system and a refrigerant circuit.

This object is achieved, in an example, by a coolant system for electric vehicles, which is characterized in that only a single multi-way valve and a single non-return valve are designed and arranged in such a way that one of the components and another of the components are fluidically connectable to each other only with the aid of a further component designed as a coolant pump and with the aid of a predetermined switching state of the multi-way valve to permit a flow through the multi-way valve and the non-return valve independently of a rest of the components. The one component and the other component may each be designed as any reasonable and suitable component of the coolant system according to the invention through which the coolant may flow. This object is furthermore achieved by a thermal management system for electric vehicles.

An essential advantage of the invention is, in particular, that a coolant system for an electric vehicle and a thermal management system for an electric vehicle, which includes a coolant system and a refrigerant circuit, are improved. Based on the invention, functionally complex coolant systems and thermal management systems for electric vehicles may be more easily implemented in terms of construction and manufacturing. Correspondingly, the number of coolant lines and valves is significantly reduced. At the same time, the efficiency of coolant systems and thermal management systems of this type is increased by means of the invention, since the aforementioned systems permit greater functional complexity with significantly fewer components, compared to the prior art. Correspondingly, a multiplicity of operating states, i.e., operating modes of the system, may be implemented with the aid of a simply designed system having few components, valves, and coolant lines.

The thermal management system according to the invention for an electric vehicle and the coolant system according to the invention for an electric vehicle can be freely selectable within broad, suitable parameters, depending on the type, functionality, material, and dimensioning. In addition, the invention is not limited to an application in purely electric vehicles. For example, the invention may also be advantageously used in so-called hybrid vehicles.

The valves can be designed only as the single multi-way valve and the single non-return valve. The number of the valves needed for the coolant system according to the invention is reduced to a minimum hereby.

The one component, the other component, and the further component designed as a coolant pump can be arranged in a partial circuit of the coolant separate from the rest of the components during the joint flow of coolant through them. In this way, a complete fluidic separation of the three aforementioned components from the rest of the components of the coolant system is made possible.

The plurality of components can include at least a subset of the following components of a thermal management system: coolant tank, coolant pump, battery, chiller, coolant heater, power train including an electric motor and power electronics for the electric motor, cooling air radiator for exchanging heat with free surroundings, and/or condenser for a refrigerant circuit. The aforementioned components may also be installed in a plurality of the particular components in the coolant system according to the invention. Essential components for a coolant system are specified hereby for the coolant system according to the invention.

An example of the coolant system according to the invention provides that the two components fluidically connectable only with the aid of the multi-way valve and the non-return valve are, on the one hand, a cooling air radiator for exchanging heat of the coolant with free surroundings and, on the other hand, a chiller for exchanging heat with a refrigerant circuit for air-conditioning a passenger cell of the electric vehicle and/or for controlling the temperature of the coolant flowing in the coolant circuit. In this way, the one of the components and the other of the components are implemented in a particularly suitable manner. The battery is usually able to be cooled with the aid of the chiller to a temperature range necessary for its function, despite disadvantageous environmental and/or operating conditions of the electric vehicle. However, the chiller may also be additionally or alternatively used for other cooling tasks, for example for cooling the power train. The waste heat resulting during any type of cooling with the aid of the thermal management system according to the invention, using the coolant system according to the invention, i.e., also the waste heat of the chiller, may be sensibly used, depending on the switching state of the multi-way valve, to heat other areas of the vehicle, for example, a passenger cell, or to heat other components of the coolant system. According to the present refinement of the coolant system according to the invention, it is furthermore possible that the coolant is cooled below an ambient temperature and then reheated by an ambient air passing through the cooling air radiator. The heat absorbed in this way is output to the refrigerant circuit by the chiller in the next circulation step, provided that the latter is in heat transfer connection to the refrigerant circuit, and the described process begins all over again.

The chiller and a component designed as a battery can be fluidically arranged in such a way that coolant may flow through the chiller independently of the battery. In this way, the chiller may be used, in particular, independently of the battery, for example, only in connection with the aforementioned cooling air radiator.

The battery may be fluidically disconnected from a rest of the coolant system only with the aid of an additional valve, for example a 3/2-way valve, of the coolant system. The battery may be particularly easily fluidically disconnected hereby from the rest of the coolant system in terms of construction and circuitry.

The multi-way valve can be designed in such a way that the coolant may flow through the power train without interruption in all possible switching states of the multi-way valve and when the multi-way valve transitions from one of these switching states into another of these switching states. This ensures that the power train, and thus the power electronics and the electric motor, are safely cooled to a temperature necessary for their proper functioning under all environmental and operating conditions of the electric vehicle.

The coolant system can be designed in such a way that, depending on the switching state of the multi-way valve, the following coolant-conducting connections may be implemented at least in a subset, preferably all thereof, only with the aid of the multi-way valve and the non-return valve: a) coolant-conducting connection of the chiller to the battery; b) coolant-conducting connection of the chiller to the power train; c) coolant-conducting connection of the chiller to the cooling air radiator; d) coolant-conducting connection of the chiller to the cooling air radiator and the power train; e) coolant-conducting connection of the chiller to the battery and the power train; and f) coolant-conducting connection of the chiller to the battery, the cooling air radiator, and the power train. In this way, the coolant system according to the invention may be used particularly flexibly and thus also for temperature control tasks in an electric vehicle which themselves are extremely demanding in terms of circuitry.

The advantages associated with the coolant system according to the invention may also be used for the thermal management system according to the invention, which comprises a coolant system and a refrigerant circuit.

The refrigerant circuit can be designed to air-condition a passenger cell of the electric vehicle and/or to control the temperature of a coolant flowing in the coolant system. This makes it possible to use the refrigerant circuit in a particularly advantageous manner.

The thermal management system can be designed in such a way that a heat transfer connection between the coolant system, on the one hand, and the refrigerant circuit, on the other hand, may be established as needed with the aid of the chiller. In this way, in addition to a temperature control of the refrigerant circuit, i.e., a refrigerant flowing in the refrigerant circuit, a temperature control of the coolant system may also be very easily made possible in terms of construction and manufacturing with the aid of the thermal management system. The chiller is thus a component of the coolant system as well as of the refrigerant circuit.

The thermal management system can be designed in such a way that a heat transfer connection between the coolant system, on the one hand, and the refrigerant circuit, on the other hand, may be established as needed with the aid of the condenser, preferably that the condenser is arranged in a coolant-conducting manner in the drive train partial circuit. For example, a component which is present in the usual refrigerant circuit for an electric vehicle, namely the condenser, may be used hereby for operating the refrigerant circuit as well as for transferring heat between the coolant system, on the one hand, and the refrigerant circuit, on the other hand. Correspondingly, advantages arise here, which are comparable to those of the aforementioned refinement of the thermal management system according to the invention. Combined with the two aforementioned refinements of the thermal management system according to the invention, a possibility furthermore arises to exchange even more energy between the coolant system and the refrigerant circuit. At the same time, the flexibility of the thermal management system is further increased thereby.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of the coolant system according to the invention for the thermal management system according to the invention in a process engineering flow diagram;

FIG. 2 shows the example in a representation similar to FIG. 1, in a first operating state of the coolant system;

FIG. 3 shows the example in a representation similar to FIG. 1, in a second operating state of the coolant system;

FIG. 4 shows the example in a representation similar to FIG. 1, in a third operating state of the coolant system;

FIG. 5 shows the example in a representation similar to FIG. 1, in a fourth operating state of the coolant system;

FIG. 6 shows the example in a representation similar to FIG. 1, in a fifth operating state of the coolant system; and

FIG. 7 shows the example in a representation similar to FIG. 1, in a sixth operating state of the coolant system.

### DETAILED DESCRIPTION

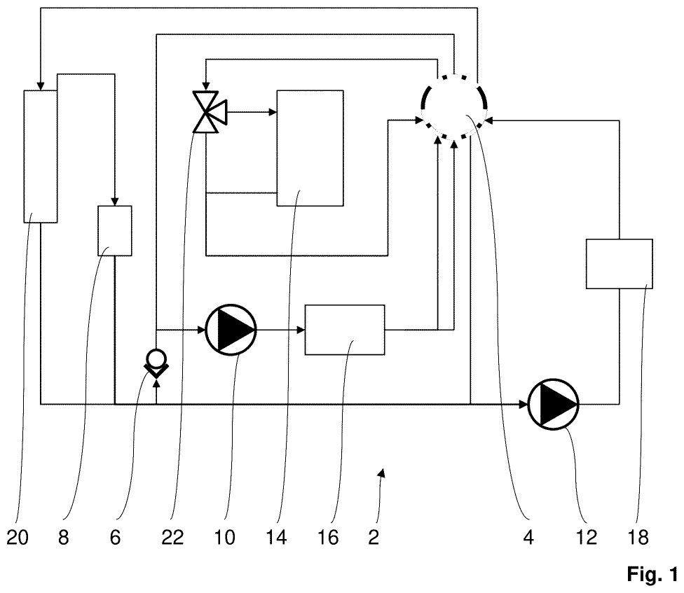

An example of the coolant system according to the invention of a thermal management system is shown in FIGS. 1 through 7 purely as an example.

The thermal management system is designed as a thermal management system for a purely electric vehicle and comprises a coolant system 2, on the one hand, and a refrigerant circuit, on the other hand. The refrigerant circuit is designed to air-condition a passenger cell of the electric vehicle, and to control the temperature of a coolant flowing within coolant system 2. Coolant system 2 is illustrated in FIG. 1.

Coolant system 2 for circulating a liquid coolant comprises in this case a plurality of components through which the coolant may flow, the components being connectable to each other, at least in at least one subset, in a coolant-conducting manner with the aid of valves and with the aid of coolant lines.

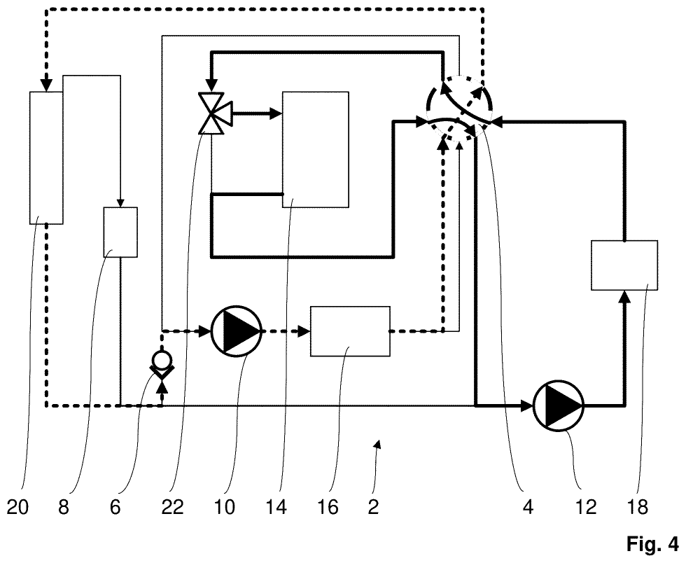

The coolant system 2 is designed in such a way that only a single multi-way valve 4 and a single non-return valve 6 are designed and arranged in such a way that one of components 20 and another of components 16 are fluidically connectable to each other only with the aid of a further component 10 designed as a coolant pump and a predetermined switching state of multi-way valve 4 to permit a flow through multi-way valve 4 and non-return valve 6 independently of a rest of components 8, 12, 14, 18. Also see FIG. 4.

The components can be designed as a coolant tank 8, a first coolant pump 10, a second coolant pump 12, a battery 14, a chiller 16, a power train 18 including an electric motor and power electronics for the electric motor, and a cooling air radiator 20 for exchanging heat with free surroundings.

The three aforementioned components which are fluidically connected to each other only with the aid of a predetermined switching state of multi-way valve 4 to permit a flow through multi-way valve 4 and non-return valve 6 are designed in this case as cooling air radiator 20 for exchanging heat of the coolant with free surroundings, chiller 16 for exchanging heat with a refrigerant circuit for air-conditioning the passenger cell of the electric vehicle and for controlling the temperature of the coolant flowing in coolant circuit 2, and designed as coolant pump 10, cooling air radiator 20, chiller 16, and first coolant pump 10 being arranged in a partial circuit of the coolant separate from a rest of components 8, 12, 14, 18 of coolant system 2 during the joint flow of coolant through them.

In the present example, chiller 16 and battery 14 are fluidically arranged in such a way that coolant may flow through chiller 16 independently of battery 14. Also see, for example, FIG. 4.

Battery 14 may also be fluidically disconnected from a rest of coolant system 2 with the aid of a 3/2-way valve 22 of coolant system 2. Correspondingly, the present example of the coolant system according to the invention includes in this case a total of only three valves, namely multi-way valve 4, non-return valve 6, and 3/2-way valve 22. However, specific examples of the coolant system according to the invention are also conceivable, in which the coolant system includes only a single multi-way valve and a single non-return valve.

Multi-way valve 4 can be designed in such a way that the coolant may flow through power train 18 without interruption in all possible switching states of multi-way valve 4 and when multi-way valve 4 transitions from one of these switching states into another of these switching states.

The coolant system 2 can be designed in such a way that, depending on the switching state of multi-way valve 4, the following coolant-conducting connections may all be implemented only with the aid of multi-way valve 4 and non-return valve 6: a) coolant-conducting connection of chiller 16 to battery 14; b) coolant-conducting connection of chiller 16 to power train 18; c) coolant-conducting connection of chiller 16 to cooling air radiator 20; d) coolant-conducting connection of chiller 16 to cooling air radiator 20 and power train 18; e) coolant-conducting connection of chiller 16 to battery 14 and power train 18; and f) coolant-conducting connection of chiller 16 to battery 14, cooling air radiator 20, and power train 18.

The thermal management system can be designed in such a way that a heat transfer connection between coolant system 2, on the one hand, and the refrigerant circuit, on the other hand, may be established as needed with the aid of chiller 16.

The functionality of the thermal management system according to the invention, including the coolant system according to the invention, is explained in greater detail below according to the present example, based on FIGS. 1 through 7.

Depending on the operating state of the thermal management system, including coolant system 2, and taking into account the driving situation and the ambient temperature, the aforementioned components of coolant system 2 may represent heat sources or heat sinks.

The efficiency of the overall system, i.e., the thermal management system including coolant system 2, may be improved by a connection or disconnection of the individual aforementioned components as needed. According to the invention, this is done particularly easily in terms of construction and manufacturing, with the overall system being highly efficient at the same time.

For example, battery 14 in the cold state may be efficiently heated up during driving by the waste heat of power train 18, namely, the power electronics and the electric motor. For this purpose, battery 14 may be coolant-conductively connected to the power electronics and the electric motor, i.e., to power train 18. At very high ambient temperatures, however, a disconnection of battery 14 from power train 18 is absolutely necessary, so that only heat-sensitive battery 14 may be cooled with the aid of chiller 16.

In particular, heating the interior, i.e., the passenger cell, poses a major challenge, since power train 18 usually does not generate enough waste heat in an electric vehicle, compared to a vehicle including an internal combustion engine. For this reason, chiller 16 is used to supply heat from all available heat sources of coolant system 2 to the refrigerant circuit, i.e., the heat pump. The waste heat from battery 14, power train 18, or from an ambient air, which is transferred to the coolant with the aid of cooling air radiator 20, is therefore supplied to chiller 16 depending on availability, in that a coolant-conducting connection is established between these components.

To be able to optimally combine the waste heat from battery 14 and/or power train 18 and/or from the ambient air, taking into account all conceivable driving states and environmental conditions, a multiplicity of coolant-conducting connections are needed between battery 14, power train 18, cooling air radiator 20, and chiller 16. This is made possible according to the invention, simultaneously with little structural complexity of the thermal management system including coolant system 2, i.e., simultaneously with a small number of necessary coolant lines and valves. FIG. 1 shows coolant system 2, with the aid of which the aforementioned combinations a) through f) are possible for using different heat sources of coolant system 2.

According to the invention, the structural system complexity is greatly reduced and the system efficiency significantly increased.

The combination according to the invention of the components of coolant system 2 permits the following six operating modes of coolant system 2.

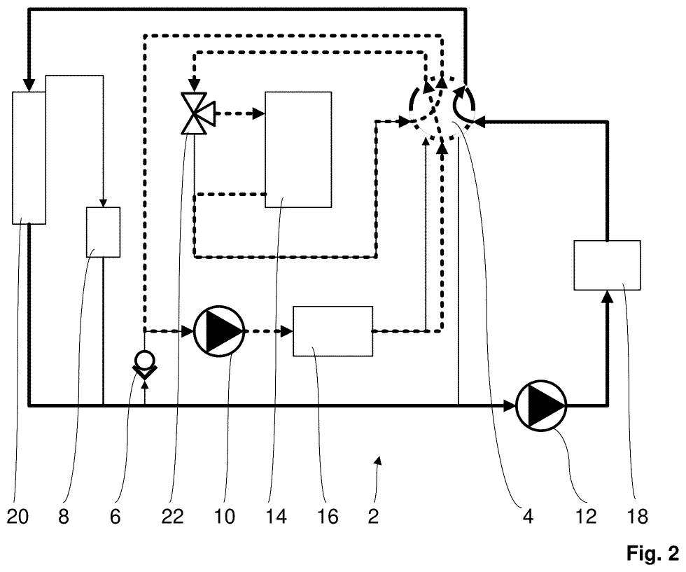

In a first operating mode of coolant system 2 and a switching state of multi-way valve 4 corresponding thereto, battery 14 is cooled separately via chiller 16; the drive train, i.e., power train 18, is connected to cooling air radiator 20 via multi-way valve 4 in a parallel partial circuit of the coolant. Also see FIG. 2. In FIGS. 1 through 7, the cooling lines of coolant system 2 through which coolant flows are each drawn in bold font, using solid or dashed lines. This first operating state of coolant system 2 corresponds to aforementioned coolant-conducting connection a.

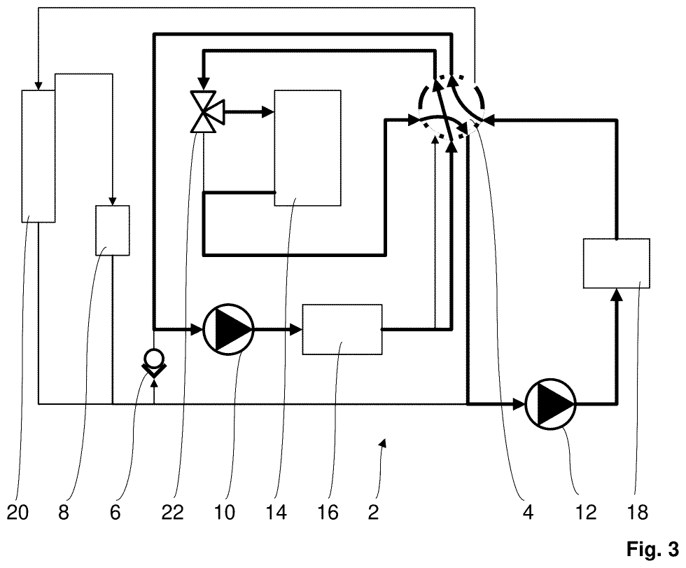

In a second operating mode of coolant system 2 as an alternative to the aforementioned waste heat use case, with a corresponding switching state of multi-way valve 4, battery 14 and power train 18, together with chiller 16, are combined in a common partial circuit of the coolant. Cooling air radiator 20 is not connected. Also see FIG. 3. This second operating mode of coolant system 2 corresponds to aforementioned coolant-conducting connections b and e. The 3/2-way valve 22 may be used to implement this circuit, for example to establish coolant-conducting connection b. However, specific examples of the invention are also conceivable, in which no valve of this type is used. Instead, the coolant is inevitably guided through the battery in the present circuit.

In a third operating mode of coolant system 2 with a corresponding switching state of multi-way valve 4, battery 14 and power train 18 are connected to each other in a common partial circuit of the coolant. In this circuit, cooling air radiator 20 is fluidically connected to chiller 16. Also see FIG. 4. Accordingly, the third operating mode of coolant system 2 corresponds to aforementioned coolant-conducting connection c.

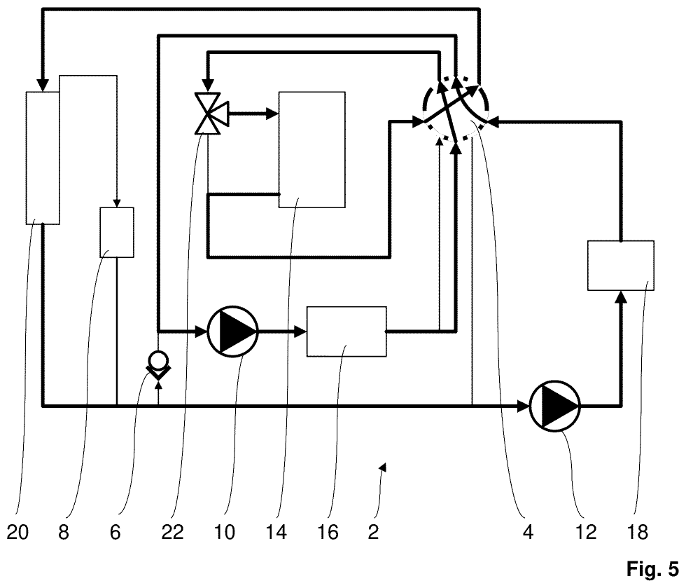

In a fourth operating mode of coolant system 2 with a corresponding switching state of multi-way valve 4, battery 14, power train 18, and chiller 16 are fluidically connected to each other in a common partial circuit of the coolant; cooling air radiator 20 in this case is additionally arranged between battery 14 and power train 18. Also see FIG. 5. Similarly to the above case, 3/2-way valve 22 may be used to implement this circuit, for example to implement coolant-conducting connection d. In this case as well, however, other example of the invention are also conceivable, in which the coolant inevitably flows through battery 14, so that 3/2-way valve 22 is not absolutely required. This operating mode thus corresponds to aforementioned coolant-conducting connections d and f.

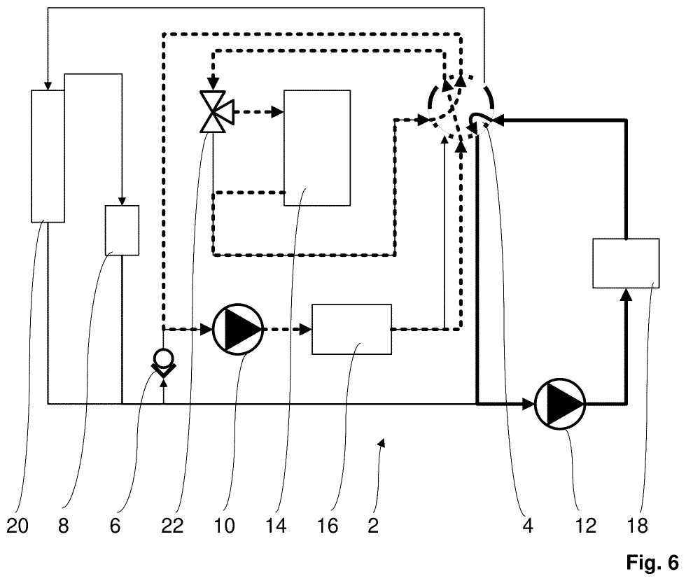

In a fifth operating mode of coolant system 2 with a corresponding switching state of multi-way valve 4, battery 14 may be heated, for example, via a separate electric block heater or the like; power train 18 forms a partial circuit of the coolant in parallel thereto with the aid of multi-way valve 4, circumventing cooling air radiator 20. Also see FIG. 6. This fifth operating state, in turn, corresponds to aforementioned coolant-conducting connection a.

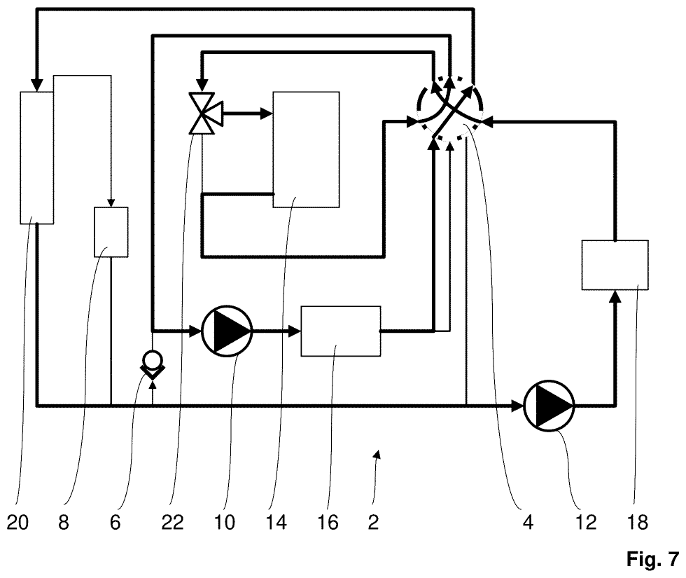

In a sixth operating mode of coolant system 2 with a corresponding switching state of multi-way valve 4, battery 14 and power train 18 form a common partial circuit of the coolant, in which power train 18 may initially supply heat to battery 14. This is fluidically followed by chiller 16 and cooling air radiator 20. Also see FIG. 7. This sixth operating state corresponds to aforementioned coolant-conducting connection f.

Based on the invention, the functionally complex thermal management system including coolant system 2 for electric vehicles may be easily implemented in terms of construction and manufacturing. It is possible to implement the aforementioned operating states of coolant system 2a through f with the aid of the combination according to the invention, in particular, with the aid of multi-way valve 4 and non-return valve 6. Correspondingly, the number of coolant lines and valves is significantly reduced. At the same time, the efficiency is increased with the aid of the thermal management system including coolant system 2, since coolant system 2 permits a greater functional complexity with significantly fewer components, compared to the prior art. Correspondingly, a multiplicity of operating states, i.e., operating modes of the thermal management system, may be implemented with the aid of a simply designed thermal management system, in particular, simply designed coolant system 2.

The invention is not limited to the present example. For example, also see the related descriptions in the introduction of the background information. In contrast to the explained example, it may, for example, be provided in other specific examples of the invention that a condenser is present, a heat transfer connection between coolant system 2, on the one hand, and the refrigerant circuit, on the other hand, being able to be established as needed alternatively or additionally to chiller 16. The condenser may preferably be arranged in a coolant-conducting manner in a drive train partial circuit including the power train.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A coolant system for an electric vehicle for circulating a liquid coolant, the coolant system comprising:
a plurality of components through which the coolant is adapted to flow, the components being connectable to each other, at least in at least one subset, in a coolant-conducting manner with the aid of valves and with the aid of coolant lines; and
a single multi-way valve and a single non-return valve being arranged such that one of the components and another of the components are fluidically connectable to each other only with the aid of a further component designed as a coolant pump and a predetermined switching state of the multi-way valve to permit a flow through the multi-way valve and the non-return valve independently of a rest of the components.

2. The coolant system according to claim 1, wherein the valves are designed only as the single multi-way valve and the single non-return valve.

3. The coolant system according to claim 1, wherein the one component, the other component, and the further component designed as a coolant pump are arranged in a partial circuit of the coolant separate from the rest of the components during the joint flow of coolant through them.

4. The coolant system according to claim 1, wherein the plurality of components includes at least a subset of the following components of a thermal management system: a coolant tank, a coolant pump, a battery, a chiller, a coolant heater, a power train including an electric motor and power electronics for the electric motor, a cooling air radiator for exchanging heat with free surroundings, and/or a condenser for a refrigerant circuit.

5. The coolant system according to claim 4, wherein the two components fluidically connectable only with the aid of the multi-way valve and the non-return valve are the cooling air radiator for exchanging heat of the coolant with free surroundings and the chiller for exchanging heat with a refrigerant circuit for air-conditioning a passenger cell of the electric vehicle and/or for controlling the temperature of the coolant flowing in the coolant system.

6. The coolant system according to claim 5, wherein the chiller and a component designed as a battery are fluidically arranged such that coolant flows through the chiller independently of the battery.

7. The coolant system according to claim 4, wherein the battery is fluidically disconnected from a rest of the components only with the aid of an additional valve or a 3/2-way valve of the coolant system.

8. The coolant system according to claim 1, wherein the multi-way valve is designed in such a way that the coolant flows through the power train without interruption in all possible switching states of the multi-way valve and when the multi-way valve transitions from one of these switching states into another of these switching states.

9. The coolant system according to claim 4, wherein the coolant system is designed in such a way that, depending on the switching state of the multi-way valve, the following coolant-conducting connections are implementable, at least in a subset, only with the aid of the multi-way valve and the non-return valve:
a) coolant-conducting connection of the chiller to the battery;
b) coolant-conducting connection of the chiller to the power train;
c) coolant-conducting connection of the chiller to the cooling air radiator;
d) coolant-conducting connection of the chiller to the cooling air radiator and the power train;
e) coolant-conducting connection of the chiller to the battery and the power train; and/or
f) coolant-conducting connection of the chiller to the battery, the cooling air radiator, and the power train.

10. A thermal management system for an electric vehicle, the system comprising:
a coolant system; and
a refrigerant circuit connectable to the coolant system in a heat-transferring manner,
wherein the coolant system is the coolant system according to claim 1.

11. The thermal management system according to claim 10, wherein the refrigerant circuit air-conditions a passenger cell of the electric vehicle and/or controls a temperature of a coolant flowing in the coolant system.

12. The thermal management system according to claim 11, wherein a heat transfer connection between the coolant system and the refrigerant circuit is established as needed via the chiller.

13. The thermal management system according to claim 11, wherein a heat transfer connection between the coolant system and the refrigerant circuit is established as needed via the condenser or wherein the condenser is arranged in a coolant-conducting manner in a drive train partial circuit with the power train.
